(19) United States
(12) Patent Application Publication
(10) Pub. No.: US 2022/0260770 A1
(43) Pub. Date: Aug. 18, 2022

(54) INTEGRATED LIGHT GUIDE PLATE AND LIGHTING DEVICE HAVING SAME

(71) Applicant: CORNING INCORPORATED, CORNING, NY (US)

(72) Inventors: Euisoo Kim, Seongnam-si (KR); Eunho Lee, Hwaseong-si (KR); JooYoung Lee, Asan-si (KR); Hong Yoon, Asan-si (KR)

(21) Appl. No.: 17/618,574

(22) PCT Filed: Jun. 10, 2020
(86) PCT No.: PCT/US2020/036950

§ 371 Date: Dec. 13, 2021

(30) Foreign Application Priority Data
Jun. 19, 2019 (KR) 10-2019-0072974

(51) Int. Cl. F21V 8/00; G02B 1/00; G02B 3/00

(52) U.S. Cl. CPC G02B 6/0035; G02B 1/002; G02F 1/133615; G02B 3/0037; G02B 6/0051

(57) ABSTRACT

Provided are an integrated light guide plate and a lighting device including the same. Micro-sized engraved lenses are provided on one surface of a transparent substrate, coated with a reflector pattern having a visually unrecognizable size, such that dual-surface lighting is realized and the ratio between intensities of dual-surface lighting is adjusted without the addition of a reflector plate and a diffuser plate. The transparent substrate includes a first surface, a second surface, and third surfaces connecting the first surface and the second surface to each other, the second surface provided with a lens pattern including engraved lenses.

### CROSS-REFERENCE TO RELATED APPLICATIONS

This application claims the benefit of priority under 35 U.S.C § 119 of Korean Patent Application No. 10-2019-0072974 filed on Jun. 19, 2019, the content of which is relied upon and incorporated herein by reference in its entirety.

### BACKGROUND

### Field

The present disclosure relates to an integrated light guide plate and a lighting device having the same and, more particularly, to an integrated light guide plate including a transparent substrate in which micro-sized engraved lenses are formed, and a lighting device having the same.

### Description of Related Art

A light guide plate is designed to guide light from light-emitting diodes (LEDs) disposed on a side surface thereof and then, emit light in the form of surface emission. Since light toward a surface of the transparent substrate at angles greater than an angle of total internal reflection is guided while being reflected within the transparent substrate, a light-scatter, able to redirect the light toward the surface of the transparent substrate, should be provided on the surface of the transparent substrate in order to extract the light through the surface thereof. Such a light-scatter may be implemented using a variety of materials and may have a variety of forms. In general, the light-scatter used is, for example, hemispherical, or polyhedral lens-shaped, and includes particles therein. For example, in the related art, a light-scatter is formed by providing spherical or polyhedral matters on a polymethyl methacrylate (PMMA) substrate using a variety of methods, such as coating, printing, bonding, or the like. However, such lenses are provided in visually-recognizable size in order to reduce costs, and the density of the light-scatter gradually increases in the direction of the center of the light guide plate in order to increase the uniformity of extracted light. For these reasons, a diffuser plate able to cover the light-scatter is additionally required in order to prevent the light-scatter from being visually recognized while increasing the uniformity of extracted light. Since the light guide plate is typically intended to extract light through one surface, a reflector plate is disposed on the other surface of the light guide plate in order to increase light guiding efficiency.

However, when the diffuser plate and reflector plate are additionally provided in front of and behind the light guide plate, the thickness of a light guide assembly including the light guide plate may be significantly increased. It may be fundamentally difficult to realize dual-surface lighting using such a light guide assembly.

In a case of attempting to provide dual-surface lighting using a light guide plate, a reflector plate should be removed. However, if the reflector plate is removed, it may be difficult to adjust the ratio between intensities of light in dual-surface lighting, although dual-surface lighting is possible.

### SUMMARY

Various aspects of the present disclosure provide an integrated light guide plate, in which micro-sized engraved lenses are provided on one surface of a transparent substrate, coated with a reflector pattern having a visually unrecognizable size, such that dual-surface lighting can be realized and the ratio between intensities of dual-surface lighting can be adjusted without the addition of a reflector plate and a diffuser plate, which are typically used to increase light guiding efficiency, and a lighting device including the same.

In this regard, the present disclosure provides an aspect of an integrated light guide plate including: a transparent substrate including a first surface, a second surface opposing the first surface, and third surfaces connecting the first surface and the second surface to each other, the second surface provided with a lens pattern including a plurality of engraved lenses.

In some embodiments, the plurality of engraved lenses may have an aspect ratio of 1.0 or less.

In some embodiments, the plurality of engraved lenses may have a width of 150 μm or less.

In some embodiments, the plurality of engraved lenses may be spaced apart from each other.

In some embodiments, at least one of the plurality of engraved lenses may include at least two engraved sub-lenses having different sizes, the at least two engraved sub-lenses partially overlapping each other.

In some embodiments, the integrated light guide plate may further include a reflector pattern including a plurality of reflectors provided on the second surface.

In some embodiments, the plurality of reflectors may include at least one first reflector provided only on the plurality of engraved lenses, at least one second reflector provided only on a portion of the second surface between the plurality of engraved lenses, and at least one third reflector provided on both of the plurality of engraved lenses and a portion of the second surface between the plurality of engraved lenses.

In some embodiments, each reflector among the plurality of reflectors may fill a portion or the entirety of the corresponding engraved lens among the plurality of engraved lenses.

In some embodiments, the integrated light guide plate may further include a light-scatter disposed between the reflector pattern and the second surface.

In some embodiments, the light-scatter may contain particles of at least one selected from among Ag, TiO₂, BaTiO₃, SnO₂, ZrO, SiO₂, and ZnO.

In some embodiments, the lens pattern occupies 0.1% to 20%, more preferably, 8% to 12%, of an area of the second surface.

In one aspect, the present disclosure provides a lighting device including: the above-described integrated light guide plate; at least one light-emitting diode facing at least one surface of the third surfaces of the integrated light guide plate; a frame providing an accommodation space for the integrated light guide plate and the light-emitting diode such that the first surface and a second surface are exposed.

In some embodiments, the lighting device may emit light through both the first surface and the second surface of the integrated light guide plate when the light-emitting diode is on.

In some embodiments, the integrated light guide plate may remain transparent when the light-emitting diode is off.

In some embodiments, the transparency of the integrated light guide plate may be 60% or higher, more preferably, 80% or higher, when the light-emitting diode is off.

In some embodiments, the haze of the integrated light guide plate may be 30% or less.

According to embodiments of the present disclosure, the micro-sized engraved lenses are provided on one surface of the transparent substrate, coated with the reflector pattern having a visually unrecognizable size, such that dual-surface lighting can be realized and the ratio between intensities of dual-surface lighting can be adjusted without the addition of a reflector plate and a diffuser plate, which are typically used to increase light guiding efficiency.

The methods and apparatuses of the present disclosure have other features and advantages that will be apparent from or that are set forth in greater detail in the accompanying drawings, the disclosures of which are incorporated herein, and in the following Detailed Description, which together serve to explain certain principles of the present disclosure.

### DESCRIPTION OF THE DRAWINGS

FIG. 1 is a schematic view illustrating an integrated light guide plate according to a first exemplary embodiment;

FIG. 2 is a reference view illustrating a result of a simulation performed using an optical simulation program to determine effects caused by an engraved lens formed on a transparent substrate using for light guiding, compared to an embossed lens;

FIG. 3 is a reference view illustrating an optical path in the integrated light guide plate according to the first exemplary embodiment and an optical path in a light guide plate using embossed lenses of the related art;

FIG. 4 is a schematic view illustrating a lighting device including the integrated light guide plate according to the first exemplary embodiment;

FIG. 5 is a schematic view illustrating an integrated light guide plate according to a second exemplary embodiment;

FIG. 6 is schematic view illustrating an integrated light guide plate according to a third exemplary embodiment;

FIG. 7 is a schematic view illustrating an integrated light guide plate according to a fourth exemplary embodiment;

FIG. 8 is a plan view schematically illustrating the integrated light guide plate according to the fourth exemplary embodiment;

FIG. 9 is a reference view illustrating a light propagation path in the integrated light guide plate according to the fourth exemplary embodiment;

FIG. 10 is a conceptual view for explaining changes in the luminance of samples depending on distances from LED chips;

FIG. 11 is graphs illustrating changes in the luminance of Samples 1 to 4 before coating of the reflectors; and

FIG. 12 is graphs illustrating changes in the luminance of Samples 1 to 4 after coating of the reflectors.

### DETAILED DESCRIPTION

Hereinafter, an integrated light guide plate and a lighting device including the same, according to exemplary embodiments, will be described in detail with reference to the accompanying drawings.

In the following description, detailed descriptions of known functions and components incorporated into the present disclosure will be omitted in the case in which the subject matter of the present disclosure is rendered unclear by the inclusion thereof.

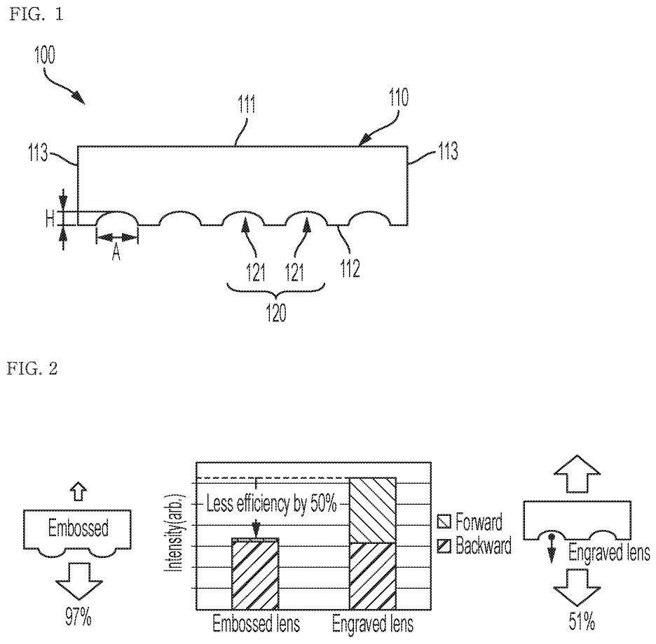

FIG. 1 is a schematic view illustrating an integrated light guide plate according to a first exemplary embodiment.

As illustrated in FIG. 1, an integrated light guide plate 100 according to a first exemplary embodiment includes a transparent substrate 110 and a lens pattern 120.

The transparent substrate 110 includes a first surface 111, a second surface 112 opposing the first surface 111, and third surface 113 connecting the first surface 111 and the second surface 112.

According to the first exemplary embodiment, the first surface 111 defines a top surface (in the drawing) of the transparent substrate 110, through which light emitted by light-emitting diodes (LEDs) 20 (in FIG. 4) exits. In addition, the second surface 112 defines a bottom surface (in the drawing) of the transparent substrate 110, through which light emitted by the LEDs 20 (in FIG. 4) exits, in the same manner as in the first surface 111. Accordingly, a lighting device 10 (in FIG. 4) including the integrated light guide plate 100 according to the first exemplary embodiment emits light through both the first surface 111 and the second surface 112 of the transparent substrate 110. In addition, the third surface 113 defines one side surface or both side surfaces of the transparent substrate 110 facing the LEDs 20 (in FIG. 4), since the lighting device 10 (in FIG. 4) is provided as an edge-lit lighting device.

According to the first exemplary embodiment, the transparent substrate 110 may be a transparent substrate having a colored or a colorless transparent substrate. Particularly, the transparent substrate 110 may be formed from a glass material in the shape of a plate. In a case in which the transparent substrate 110 is formed from a glass material, the transparent substrate 110 may be formed from an IRIS substrate available from Corning Incorporated or low-iron glass. However, this is merely illustrative, and the transparent substrate 110 according to the present disclosure is not limited to a substrate formed from a specific glass material.

According to the first exemplary embodiment, the transparent substrate 110 may be implemented using a glass material substrate having a thickness ranging from 0.5 mm to 3.0 mm.

The lens pattern 120 is comprised of a plurality of engraved lenses 121 formed on the second surface 112 of the transparent substrate 110. According to some embodiments, the plurality of engraved lenses 121 may only be formed on the second surface 112 of the transparent substrate 110. Even in the case in which the plurality of engraved lenses 121 are only formed on one surface of the transparent substrate 110, dual-surface lighting can be realized at a variety of ratios between intensities of light. According to the first exemplary embodiment, the lens pattern 120 may occupy 0.1% to 20%, particularly, 8% to 12%, and more particularly, 10%, of the area of the second surface 112 of the transparent substrate 110. Since the lens pattern 120 occupies a small area in the transparent substrate 110 as described above, the transparency of the transparent substrate 110 is not significantly influenced. According to the first exemplary embodiment, the plurality of engraved lenses 121 of the lens pattern 120 may be spaced apart from each other. The lens pattern 120 comprised of the plurality of engraved lenses 121 may be provided by performing sandblasting or etching on the transparent substrate 110.

According to the first exemplary embodiment, the engraved lenses 121 may have an aperture ratio H/A of 1.0 or less. Here, at least one engraved lens among the engraved lenses 121 may have a width of 150 μm or less, and more particularly, a width ranging from 15 μm to 40 μm. For example, each of the engraved lenses 121 may have a width 35 μm and a height 17.5 μm. However, at least one of the other engraved lens among the engraved lenses 121 may have a width greater than 150 μm. In an embodiment, each engraved lens among the plurality of engraved lenses may have a depth ranging from 10 nm to 500 μm. In an embodiment, the plurality of engraved lenses may have a pitch ranging from 0 μm (when engraved lenses overlap or are adjacent to each other) to 1 mm. In an embodiment, each engraved lens among the plurality of engraved lenses may have a circular cross-sectional shape or a non-circular cross-sectional shape including a polygonal cross-sectional shape or an elliptical cross-sectional shape.

FIG. 2 illustrates a result of simulation performed using an optical simulation program to determine effects caused by an engraved lens formed on a transparent substrate used for light guiding, compared to an embossed lens. Here, in the simulation, both the aspect ratios H/A of the embossed lens and the engraved lens were fixed to 0.5. According to the simulation, in a case in which engraved lenses were formed on a rear surface of the transparent substrate (i.e. a bottom surface of the transparent substrate in the drawing), substantially the same intensities of light exited through a front surface (i.e. a top surface in the drawing) and through the rear surface of the transparent substrate, as in the first exemplary embodiment. In this case, the ratio between intensities of light exiting through the front surface and the rear surface of the transparent substrate was determined to be 49%:51%.

In contrast, in a case in which embossed lenses were formed on the rear surface of the transparent substrate, it was determined that most of light exited through the rear surface of the transparent substrate. In this case, the ratio between intensities of light exiting through the front surface and the rear surface was determined to be 3%:97%. In addition, in a case in which embossed lenses were formed on the rear surface of the transparent substrate, it was determined that overall light emission efficiency decreased by about 50%. According to this simulation, it was appreciated that, in a case in which the embossed lens was formed on the rear surface of the transparent substrate, dual-surface lighting was difficult and overall emission efficiency was not satisfactory. In contrast, in a case in which the engraved lens was formed on the rear surface of the transparent substrate, dual-surface lighting was enabled, and overall lighting efficiency could be obtained at an excellent level.

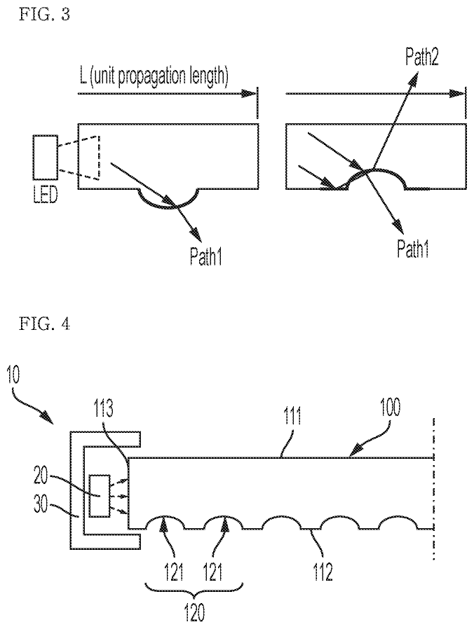

Reasons for the light emission efficiency varying depending on the lens shape may be explained with reference to FIG. 3. Referring to FIG. 3, each of thick lines in the drawing (i.e. an arc portion in the embossed lens and an arc and adjacent portions in the engraved lens) indicates a location at each of which a light path is substantially changed when light emitted by an LED strikes the location. Light striking the other locations at angles greater than a threshold angle is repeatedly totally reflected, so as to vanish sideways. Here, the physical width of the portion able to scatter light is wider in the case in which the engraved lenses are formed than in the case in which the embossed lenses are formed. According to this difference, the overall lighting efficiency is higher in the case in which the engraved lenses are formed than in the case in which the embossed lenses are formed. In addition, the case in which the engraved lenses are formed has a wider area in which light can be scattered as indicated by Path1 and Path2. Accordingly, it can be appreciated that a ratio of light exiting through the front surface is higher in the case in which the engraved lenses are formed than in the case in which the embossed lenses are formed. According to this difference, dual-surface lighting is possible when the engraved lenses are formed.

As illustrated in FIG. 4, the integrated light guide plate 100 including the transparent substrate 110 and the lens pattern 120 comprised of the plurality of engraved lenses 121 according to the first exemplary embodiment may be used in the edge-lit lighting device 10.

The lighting device 10 according to the first exemplary embodiment includes the integrated light guide plate 100, the LEDs 20, and a frame 30.

Here, the LEDs 20 may be disposed to face at least one surface of the both third surfaces 113 defining side surfaces of the integrated light guide plate 100. That is, the LEDs 20 may be disposed to face the left-side surface, the right-side surface, or both the left-side and right-side surfaces, of the integrated light guide plate 100 in the drawing. Here, at least one of the LEDs 20 may be disposed adjacent to each of the left-side and right-side surfaces.

The frame 30 provides a mounting space for the integrated light guide plate 100 and the LEDs 20. Here, according to the first exemplary embodiment, the frame 30 is disposed to expose both the first surface 111 and the second surface 112 of the integrated light guide plate 100 in order to enable dual-surface lighting. In this regard, the frame 30 may be shaped to enclose the peripheral portions of the integrated light guide plate 100.

In the lighting device 10 as described above, when the LEDs 20 are in a turned-on state, light emitted by the LEDs 20 exits through both the first surface 111 and the second surface 112 of the integrated light guide plate 100, so that dual-surface lighting of the lighting device 10 is realized. Here, substantially the same intensities of light exit through the two surfaces.

In addition, in the lighting device 10, when the LEDs 20 are in a turned-off state, the integrated light guide plate 100 remains transparent. Here, when the LEDs 20 are in the turned-off state, the transparency of the integrated light guide plate 100 may be 60% or higher, and more particularly, 80% or higher. As a result, for example, a viewer on the side of the first surface 111 may see an image behind the lighting device 10 through the integrated light guide plate 100, which is transparent.

Hereinafter, an integrated light guide plate according to a second exemplary embodiment will be described with reference to FIG. 5.

FIG. 5 is a schematic view illustrating the integrated light guide plate according to the second exemplary embodiment.

As illustrated in FIG. 5, the integrated light guide plate 200 according to the second exemplary embodiment includes a transparent substrate 110, a lens pattern 120, and a reflective pattern 230.

The second exemplary embodiment is substantially the same as the first exemplary embodiment, except for the reflective pattern being additionally provided. The same components will be denoted by the same reference numerals and detailed descriptions thereof will be omitted.

The reflective pattern 230 includes a plurality of reflectors 231 conforming to the engraved lenses 121 so as to fill the entirety of the engraved lenses 121. In the second exemplary embodiment, the cross-sectional area of the engraved lenses 121, the area of the reflectors 231 filling the engraved lenses 121, and the area in which the reflectors 231 overlap the engraved lenses 121 are the same. In a case in which the reflective pattern 230 is formed to fill the lens pattern 120, when simulation is performed using an optical simulation program, 92% of light exits through the first surface 111 of the transparent substrate 110, while 8% of light exits through the second surface 112 of the transparent substrate 110. In this simulation, the aspect ratio H/A of the engraved lenses 121 was fixed to be 0.5, and the reflectance and the light absorptivity of the reflector 231 were regarded as being 95% and 5%, respectively. As a result of the simulation using the optical simulation program, the integrated light guide plate 200 according to the second exemplary embodiment, in which the reflective pattern 230 fills the lens pattern 120, can realize dual-surface lighting, like the integrated light guide plate 100 according to the first exemplary embodiment, in which the lens pattern 120 remains hollow, although the ratio of intensities of light exiting through the first surface 111 and the second surface 112 of the integrated light guide plate 200 differs from those of the integrated light guide plate 100. This means that the ratio of intensities of light exiting through the both surfaces can be adjusted by adjusting the ratio of the reflectors 231. However, as a result of the simulation, the lighting efficiency of the second exemplary embodiment was reduced by about 20% as compared to the first exemplary embodiment.

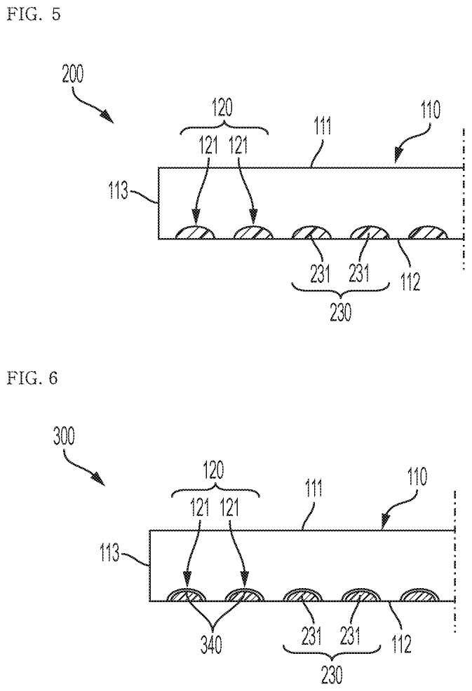

Hereinafter, an integrated light guide plate according to a third exemplary embodiment will be described with reference to FIG. 6.

FIG. 6 is schematic view illustrating the integrated light guide plate according to the third exemplary embodiment.

As illustrated in FIG. 6, the integrated light guide plate 300 according to the third exemplary embodiment includes the transparent substrate 110, the lens pattern 120, the reflective pattern 230, and a light-scatter 340.

The third exemplary embodiment is substantially the same as the second exemplary embodiment, except for the light-scatter being additionally provided. The same components will be denoted by the same reference numerals and detailed descriptions thereof will be omitted.

The light-scatter 340 is provided between the reflectors 231 of the reflective pattern 230 and the second surface 112 of the transparent substrate 110. The light-scatter 340 is intended to increase the scattering effect of the integrated light guide plate 300. The light-scatter 340 may contain particles formed from at least one selected from among, but not limited to, Ag, TiO₂, BaTiO₃, SnO₂, ZrO, SiO₂, and ZnO. The size of the particles of the light-scatter 340 may range from 20 nm to 10 μm, and more particularly, from 100 nm to 5 μm, in consideration of agglomeration, in which smaller particles collect into greater particles. When the simulation is performed on the assumption that a high-performance light-scatter 340 able to realize, for example, a Lambertian light distribution, was formed between the reflectors 231 and the second surface 112 of the transparent substrate 110, it was determined that 86% of light exited through the first surface 111 of the transparent substrate 110 while 14% of light exited through the second surface 112 of the transparent substrate 110. In addition, when the simulation is performed on the assumption that a low-performance light-scatter 340 able to realize, for example, a Gaussian light distribution, was formed between the reflectors 231 and the second surface 112 of the transparent substrate 110, it was determined that 91% of light exited through the first surface 111 of the transparent substrate 110 while 9% of light exited through the second surface 112 of the transparent substrate 110. According to the result of the simulation using the optical program, it was determined that the integrated light guide plate 300 according to the third exemplary embodiment, in which the light-scatter 340 was added, showed an increase of about two times in the ratio of intensity of light exiting through the second surface 112 when the high-performance light-scatter 340 was used and an insignificant difference in the ratio of intensity of light exiting through the second surface 112 when the low-performance light-scatter 340 was used, compared to the case in which the integrated light guide plate 200 according to the second exemplary embodiment. This means the ratio of intensities of light exiting through the two surfaces can be adjusted, through selection of a specific type of light-scatter 340.

The integrated light guide plate 300 according to the third exemplary embodiment was determined to be able to realize dual-surface lighting, like the integrated light guide plate 100 according to the first exemplary embodiment and the integrated light guide plate 200 according to the second exemplary embodiment. However, a result of the simulation showed the lighting efficiency of the third exemplary embodiment was determined as decreasing about 20%, compared to that of the first exemplary embodiment, as in the case of the second exemplary embodiment.

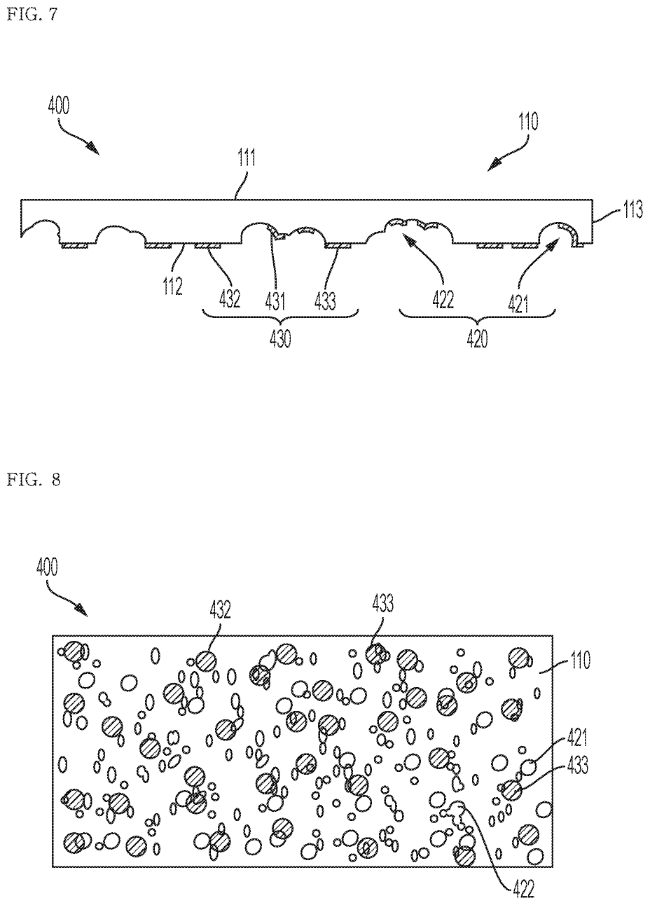

Hereinafter, an integrated light guide plate according to a fourth exemplary embodiment will be described with reference to FIGS. 7 to 9.

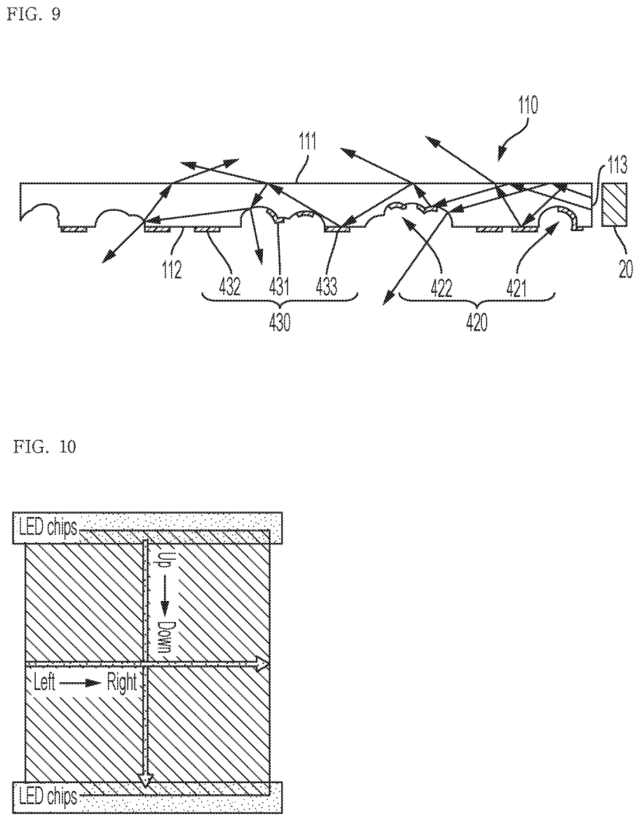

FIG. 7 is a schematic view illustrating the integrated light guide plate according to the fourth exemplary embodiment, FIG. 8 is a plan view schematically illustrating the integrated light guide plate according to the fourth exemplary embodiment, and FIG. 9 is a reference view illustrating a light propagation path in the integrated light guide plate according to the fourth exemplary embodiment.

As illustrated in FIGS. 7 to 9, the integrated light guide plate 400 according to the fourth exemplary embodiment includes the transparent substrate 110, a lens pattern 420, and a reflective pattern 430.

The fourth exemplary embodiment is substantially the same as the first and second exemplary embodiments, except for the structure of the lens pattern and the structure of the reflective pattern. The same components will be denoted by the same reference numerals and detailed descriptions thereof will be omitted.

The lens pattern 420 may include one or more engraved lenses 421 and one or more engraved lenses 422. Each of the engraved lenses 422 is comprised of two or more engraved sub-lenses having different sizes.

In addition, the reflective pattern 430 may include: reflectors 431, each of which is formed on the corresponding one of the engraved lenses 421 and 422; reflectors 432, each of which is formed on a portion of the second surface 112 of the transparent substrate 110 between the adjacent engraved lenses; and reflectors 433, each of which is formed on both the corresponding one of the engraved lenses 421 and 422 and a portion of the second surface 112 between the adjacent engraved lenses. In the reflective pattern 430, each of the reflectors 431 formed on the engraved lenses 421 and 422 may be configured to fill a portion of the engraved lens 421 or 422, or may be configured to fill the entirety of the engraved lens 421 or 422, as in the second exemplary embodiment. As described above, the ratio of intensities of light exiting through the both surfaces may differ depending on whether a portion of the engraved lenses 421 and 422 is filled with the reflectors 431 or the entirety of the engraved lenses 421 and 422 is filled with the reflectors 431. That is, the ratio of intensities of light exiting through the both surfaces can be adjusted, through adjustment in the ratio at which the engraved lenses 421 and 422 are filled with the reflectors 431.

Referring to FIG. 9, light emitted by the LEDs 20 is reflected by the engraved lenses 421 and 422 or the reflectors 431, 432, and 433 while being guided along the transparent substrate 110, and then, exits through the first surface 111 or the second surface 112 of the transparent substrate 110.

The fourth exemplary embodiment provides a structure by which the integrated light guide plate 400 can be realized at a lower cost than the other exemplary embodiments.

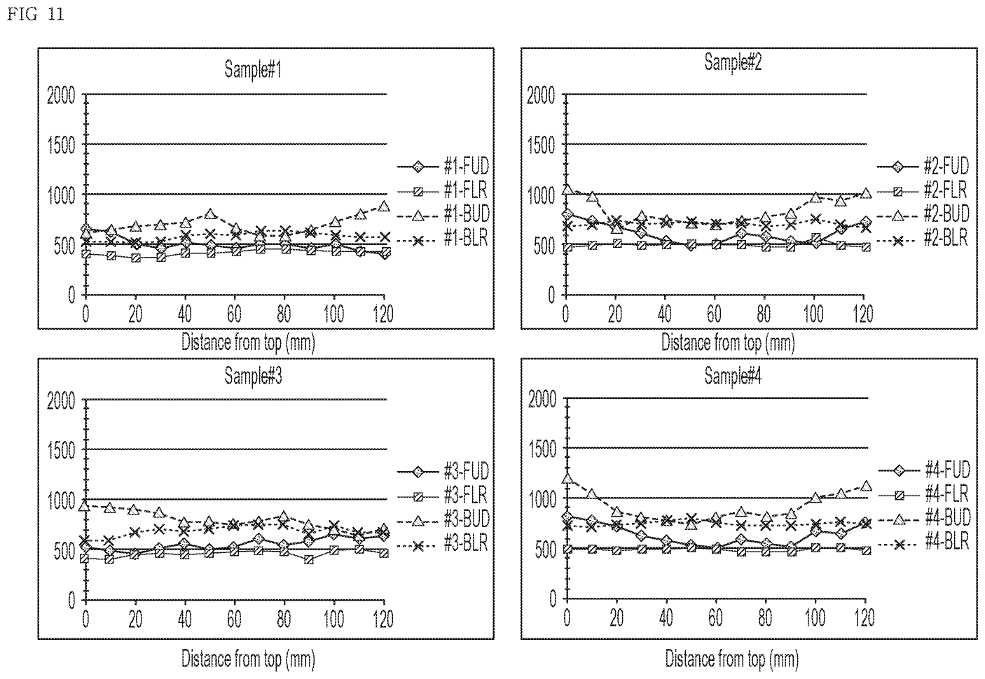

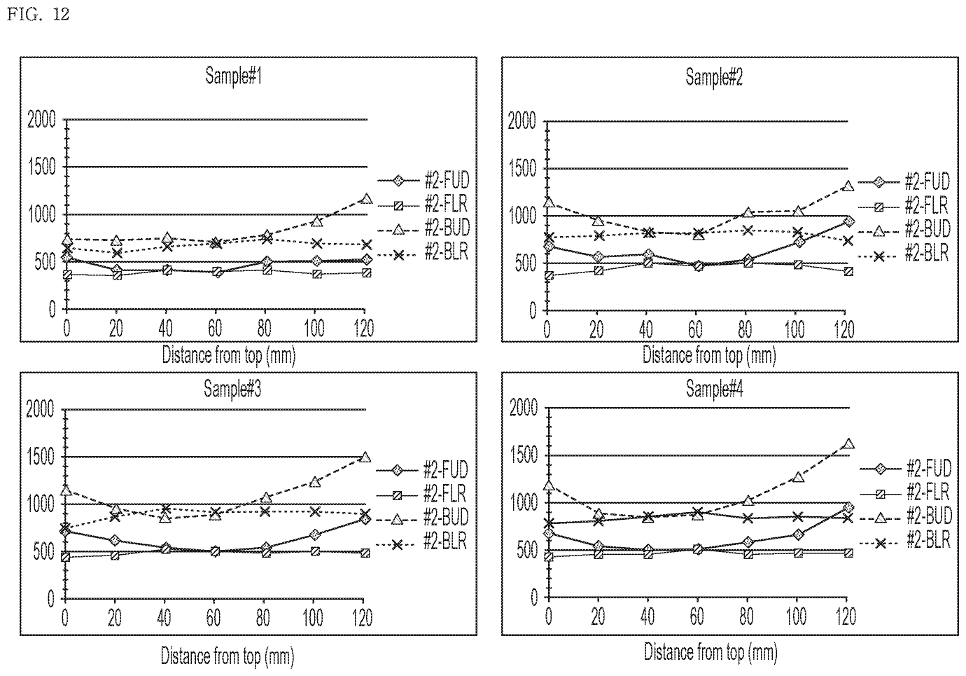

Hereinafter, measurement results of samples provided to determine optical and luminous characteristics of the integrated light guide plate according to exemplary embodiments will be described with reference to FIGS. 10 to 12.

### Sample 1

In the case of Sample 1 in which engraved lenses are formed, the average transparency of the front and rear surfaces was measured as 92.3%, and the haze of the front and rear surfaces was measured as 2.3%. Here, the luminance of the front surface was measured as 408 cd/m², and the luminance of the rear surface was measured as 563 cd/m², with the ratio of the luminance of the front surface to the rear surface being measured as 1 to 1.4. In a case in which the reflectors occupied 10% of the entire area, the average transmittance of the front and rear surfaces was measured as 86.6%, and the haze of the front and rear surfaces was measured as 2.8%. Here, the luminance of the front surface was measured as 389 cd/m², and the luminance of the rear surface was measured as 671 cd/m², with the ratio of the luminance of the front surface to the rear surface being measured as 1 to 1.7.

Referring to FIGS. 10 to 12, before the coating of the reflectors, the luminance of the front surface of Sample 1 was measured as 489 cd/m² when measured in the front-up-down (FUD) direction and 408 cd/m² when measured in the front-left-right (FLR) direction. In addition, the luminance of the rear surface of Sample 1 was measured as 685 cd/m² when measured in the back-up-down (BUD) direction and 563 cd/m² when measured in the back-left-right (BLR) direction.

In addition, after the coating of the reflectors, the luminance of the front surface of Sample 1 was measured as 475 cd/m² when measured in the FUD direction and 389 cd/m² when measured in the FLR direction. In addition, the luminance of the rear surface of Sample 1 was measured as 828 cd/m² when measured in the BUD direction and 671 cd/m² when measured in the BLR direction.

### Sample 2

In the case of Sample 2 in which engraved lenses are formed, the average transparency of the front and rear surfaces was measured as 92.1%, and the haze of the front and rear surfaces was measured as 3.6%. Here, the luminance of the front surface was measured as 497 cd/m², and the luminance of the rear surface was measured as 705 cd/m², with the ratio of the luminance of the front surface to the rear surface being measured as 1 to 1.4. In a case in which the reflectors occupied 10% of the entire area, the average transmittance of the front and rear surfaces was measured as 85.1%, and the haze of the front and rear surfaces was measured as 3.9%. Here, the luminance of the front surface was measured as 460 cd/m², and the luminance of the rear surface was measured as 804 cd/m², with the ratio of the luminance of the front surface to the rear surface being measured as 1 to 1.7.

Referring to FIGS. 10 to 12, before the coating of the reflectors, the luminance of the front surface of Sample 2 was measured as 611 cd/m² when measured in the FUD direction and 497 cd/m² when measured in the FLR direction. In addition, the luminance of the rear surface of Sample 2 was measured as 838 cd/m² when measured in the BUD direction and 705 cd/m² when measured in the BLR direction.

In addition, after the coating of the reflectors, the luminance of the front surface of Sample 2 was measured as 646 cd/m² when measured in the FUD direction and 460 cd/m² when measured in the FLR direction. In addition, the luminance of the rear surface of Sample 2 was measured as 1024 cd/m² when measured in the BUD direction and 804 cd/m² when measured in the BLR direction.

### Sample 3

In the case of Sample 3 in which engraved lenses are formed, the average transparency of the front and rear surfaces was measured as 91.2%, and the haze of the front and rear surfaces was measured as 6.3%. Here, the luminance of the front surface was measured as 459 cd/m², and the luminance of the rear surface was measured as 681 cd/m², with the ratio of the luminance of the front surface to the rear surface being measured as 1 to 1.5. In a case in which the reflectors occupied 10% of the entire area, the average transmittance of the front and rear surfaces was measured as 85.7%, and the haze of the front and rear surfaces was measured as 6.3%. Here, the luminance of the front surface was measured as 489 cd/m², and the luminance of the rear surface was measured as 888 cd/m², with the ratio of the luminance of the front surface to the rear surface being measured as 1 to 1.8.

Referring to FIGS. 10 to 12, the luminance of the front surface of Sample 3 was measured as 547 cd/m² when measured in the FUD direction and 459 cd/m² when measured in the FLR direction. In addition, the luminance of the rear surface of Sample 3 was measured as 798 cd/m² when measured in the BUD direction and 681 cd/m² when measured in the BLR direction.

In addition, after the coating of the reflectors, the luminance of the front surface of Sample 3 was measured as 632 cd/m² when measured in the FUD direction and 489 cd/m² when measured in the FLR direction. In addition, the luminance of the rear surface of Sample 1 was measured as 1095 cd/m² when measured in the BUD direction and 888 cd/m² when measured in the BLR direction.

### Sample 4

In the case of Sample 4 in which engraved lenses are formed, the average transparency of the front and rear surfaces was measured as 91.1%, and the haze of the front and rear surfaces was measured as 8.1%. Here, the luminance of the front surface was measured as 497 cd/m², and the luminance of the rear surface was measured as 705 cd/m², with the ratio of the luminance of the front surface to the rear surface being measured as 1 to 1.4. In a case in which the reflectors occupied 10% of the entire area, the average transmittance of the front and rear surfaces was measured as 84.3%, and the haze of the front and rear surfaces was measured as 8.1%. Here, the luminance of the front surface was measured as 462 cd/m², and the luminance of the rear surface was measured as 837 cd/m², with the ratio of the luminance of the front surface to the rear surface being measured as 1 to 1.8.

Referring to FIGS. 10 to 12, the luminance of the front surface of Sample 4 was measured as 626 cd/m² when measured in the FUD direction and 478 cd/m² when measured in the FLR direction. In addition, the luminance of the rear surface of Sample 4 was measured as 912 cd/m² when measured in the BUD direction and 734 cd/m² when measured in the BLR direction.

In addition, after the coating of the reflectors, the luminance of the front surface of Sample 4 was measured as 626 cd/m² when measured in the FUD direction and 462 cd/m² when measured in the FLR direction. In addition, the luminance of the rear surface of Sample 1 was measured as 1100 cd/m² when measured in the BUD direction and 837 cd/m² when measured in the BLR direction.

Samples 1 to 4 showed that the luminance of the rear surface was improved by all the reflectors, thereby changing the ratio of luminance of the front surface to the rear surface.

The foregoing descriptions of specific exemplary embodiments of the present disclosure have been presented with respect to the drawings and are not intended to be exhaustive or to limit the present disclosure to the precise forms disclosed herein, and many modifications and variations would obviously be possible for a person having ordinary skill in the art in light of the above teachings.

It is intended, therefore, that the scope of the present disclosure not be limited to the foregoing embodiments, but be defined by the Claims appended hereto and their equivalents.

1. An integrated light guide plate comprising:
a transparent substrate comprising a first surface, a second surface opposing the first surface, and third surfaces connecting the first surface and the second surface to each other, the second surface provided with a lens pattern comprising a plurality of engraved lenses.

2. The integrated light guide plate of claim 1, wherein the plurality of engraved lenses have an aspect ratio of 1.0 or less.

3. The integrated light guide plate of claim 2, wherein the plurality of engraved lenses have a width of 150 μm or less.

4. The integrated light guide plate of claim 1, wherein each of the plurality of engraved lenses has a circular cross-sectional shape or a non-circular cross-sectional shape including a polygonal cross-sectional shape or an elliptical cross-sectional shape.

5. The integrated light guide plate of claim 1, wherein each of the plurality of engraved lenses has a depth ranging from 10 nm to 500

6. The integrated light guide plate of claim 1, wherein each of the plurality of engraved lenses has a pitch ranging from 0 μm to 1 mm.

7. The integrated light guide plate of claim 1, to 6, wherein the plurality of engraved lenses are spaced apart from each other.

8. The integrated light guide plate of claim 1, wherein at least one of the plurality of engraved lenses comprises at least two engraved sub-lenses having different sizes, the at least two engraved sub-lenses partially overlapping each other.

9. The integrated light guide plate of claim 1, further comprising a reflector pattern comprising a plurality of reflectors provided on the second surface.

10. The integrated light guide plate of claim 9, wherein the plurality of reflectors comprise at least one first reflector provided only on the plurality of engraved lenses, at least one second reflector provided only on a portion of the second surface between the plurality of engraved lenses, and at least one third reflector provided on both of the plurality of engraved lenses and a portion of the second surface between the plurality of engraved lenses.

11. The integrated light guide plate of claim 10, wherein each reflector among the plurality of reflectors formed on the engraved lenses fills a portion or the entirety of the corresponding engraved lens among the plurality of engraved lenses on which the reflector is formed.

12. The integrated light guide plate of claim 10, further comprising a light-scatter disposed between the reflector pattern and the second surface.

13. The integrated light guide plate of claim 12, wherein the light-scatter contains particles of at least one selected from among Ag, TiO₂, BaTiO₃, SnO₂, ZrO, SiO₂, and ZnO.

14. The integrated light guide plate of claim 1, wherein the lens pattern occupies 0.1% to 20% of an area of the second surface.

15. The integrated light guide plate of claim 12, wherein the lens pattern occupies 8% to 12% of the area of the second surface.

16.-22. (canceled)
